(19) United States
(12) Patent Application Publication
(10) Pub. No.: US 2011/0029326 A1
(43) Pub. Date: Feb. 3, 2011

(54) INTERACTIVE HEALTHCARE MEDIA DEVICES AND SYSTEMS

(75) Inventor: Medhi Venon, Whitefish Bay, WI (US)

Correspondence Address: HANLEY, FLIGHT & ZIMMERMAN, LLC, 150 S. WACKER DRIVE, SUITE 2100, CHICAGO, IL, 60606, US

(73) Assignee: GENERAL ELECTRIC COMPANY, A NEW YORK CORPORATION, Schenectady, NY (US)

(21) Appl. No.: 12/510,918

(22) Filed: Jul. 28, 2009

(51) Int. Cl. G06Q 50/00

(52) U.S. Cl. 705/3

(57) ABSTRACT

Interactive healthcare media devices and systems are disclosed herein. An example method for use with a healthcare information system includes synchronizing a physician record library with a repository to include findings of an analysis performed by a reviewing practitioner, wherein the physician has access to the record library via a first portable device capable of outputting a multimedia presentation of the findings, wherein the first portable device is to enable the physician to modify the findings to generate a report; in response to receiving the report, synchronizing a patient record library with the repository to include the report, wherein the patient has access to the patient record library via a second portable device capable of outputting a multimedia presentation of the report, wherein the second portable device is to enable the patient to generate a response regarding the report; and in response to receiving the response from the second portable device, conveying the response to the physician record library

### FIELD OF THE DISCLOSURE

The present disclosure relates generally to healthcare information systems and, more particularly, to interactive healthcare media devices and systems.

### BACKGROUND

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), healthcare information exchanges (HIE) that provide access to, for example, information portals for affiliated practitioners and/or patients, and electronic medical records (EMR). Information stored may include patient medical histories, imaging data, imaging reports, quantitative and qualitative imaging results, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

### SUMMARY

An example computer implemented method for use with a healthcare information system includes synchronizing a physician record library with a repository to include findings of an analysis performed by a reviewing practitioner, wherein the physician has access to the record library via a first portable device capable of outputting a multimedia presentation of the findings, wherein the first portable device is to enable the physician to modify the findings to generate a report. Further, the example method includes, in response to receiving the report, synchronizing a patient record library with the repository to include the report, wherein the patient has access to the patient record library via a second portable device capable of outputting a multimedia presentation of the report, wherein the second portable device is to enable the patient to generate a response regarding the report. Further, the example method includes, in response to receiving the response from the second portable device, conveying the response to the physician record library.

An example article of manufacture has instructions stored thereon that, when executed, cause a machine to synchronize a physician record library with a repository to include findings of an analysis performed by a reviewing practitioner, wherein the physician has access to the record library via a first portable device capable of outputting a multimedia presentation of the findings, wherein the first portable device is to enable the physician to modify the findings to generate a report. Further, the example article of manufacture has instructions stored thereon that, when executed, cause a machine to, in response to receiving the report, synchronize a patient record library with the repository to include the report, wherein the patient has access to the patient record library via a second portable device capable of outputting a multimedia presentation of the report, wherein the second portable device is to enable the patient to generate a response regarding the report. Further, the example article of manufacture has instructions stored thereon that, when executed, cause a machine to, in response to receiving the response from the second portable device, convey the response to the physician record library.

A first example portable interactive media device includes a record library to store a plurality of healthcare records. Further, the first example device includes a synchronization module to synchronize the record library with a repository. Further, the first example device includes a text-to-audio converter to convert at least a portion of a first healthcare record reflecting findings of an analysis into an audio representation such that a visual representation of the findings and the audio representation are to be presented to a user at a substantially similar time. Further, the first example device includes a report generator to enable the user to modify the first healthcare record to generate a report to be conveyed to a corresponding patient, wherein modifying the first healthcare record is to include retrieving external reference material and inserting the reference material into the findings.

A second example portable interactive media device includes a record library to store a plurality of healthcare records. Further, the first example device includes a synchronization module to synchronize the record library with a repository. Further, the second example device a text-to-audio converter to convert at least a portion of a first healthcare record reflecting a report generated by a practitioner into an audio representation such that a visual representation of the report and the audio representation are to be presented to a user at a substantially similar time. Further, the second example device includes a response generator to enable a patient to generate a response to the report generated by the practitioner, wherein the response is to be conveyed to the practitioner via a management system.

### BRIEF DESCRIPTION OF THE DRAWINGS

FIG. 1 is a block diagram of an example healthcare information system.

FIG. 2 is a block diagram of an example apparatus that may be used to implement the example interactive device management system of FIG. 1.

FIG. 3 is a block diagram of an example apparatus that may be used to implement the example physician interactive media device of FIG. 1.

FIG. 4 is a block diagram of an example apparatus that may be used to implement the example patient interactive media device of FIG. 1.

FIG. 5A is a sequence diagram representing machine readable instructions that may be executed to implement example components of the example healthcare information system of FIGS. 1, 2, 3, and/or 4.

FIG. 5B is a sequence diagram representing machine readable instructions that may be executed to implement example components of the example healthcare information system of FIGS. 1, 2, 3, and/or 4.

FIG. 6 is a flow diagram representative of example machine readable instructions that may be executed to implement example components of the example healthcare information system of FIGS. 1, 2, 3, and/or 4.

FIGS. 7A-7C illustrate an example device capable of implementing the example physician interactive media device of FIGS. 1 and/or 3 and/or the example patient interactive media device of FIGS. 1 and/or 4.

FIG. 8 is a block diagram of an example processor system that may be used to execute the machine readable instructions of FIGS. 5A, 5B, and/or 6 to implement the example interactive healthcare devices of FIGS. 1, 2, 3, 4, 7A, 7B, and/or 7C.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

A healthcare practitioner typically manages a large amount of patients, systems, and tasks. To provide quality healthcare to each patient of his or her demanding workload, practitioners often rely on a plurality of devices, equipment, and/or systems to, for example, retrieve information, review medical documentation, generate reports and/or analyses, communicate with patients, etc. Access to one or more of the devices is often limited due to inadequate resources, immobility, geographic restrictions, lack of authorization, and/or other factors. In some instances, a lack of interoperability between the devices increases delay and inconvenience associated with the use of multiple devices in a healthcare workflow.

The example methods, apparatus, systems, and/or articles of manufacture described herein improve workflow by, for example, centralizing one or more tasks of a typical healthcare workflow using a device having minimal access limitations. Generally, the example methods, apparatus, systems, and/or articles of manufacture described herein provide a practitioner and/or other type of user an interactive healthcare media device (e.g., a portable, handheld tool) capable of, for example, providing the practitioner with the most recent and/or archived healthcare information related to a plurality of patients, presenting multimedia data to the practitioner, enabling the practitioner to modify, add to, and/or otherwise manipulate the healthcare information to generate a report associated with the healthcare information, communicating the generated report to a patient and/or any other interested entity (e.g., a relative of the patient), and/or providing other functionality described in greater detail herein.

Further, recent technological advancements have increased the availability of electronic medial information (e.g., records, images, reports, results, etc.) to patients. In some instances, patients receive some type of electronic communication including medical information without a traditional encounter with a healthcare practitioner. In addition, the heavy workload of the practitioner usually limits the availability of the practitioner to his or her patients. Thus, while technological advances in electronic record sharing have improved many aspects of the healthcare system, in some aspects the advancements may reduce an already low frequency of one-on-one communication between patients and practitioners.

The example methods, apparatus, systems, and/or articles of manufacture described herein provide patients an improved ability to communicate with one or more practitioners regarding healthcare information. Generally, the example methods, apparatus, systems, and/or articles of manufacture described herein provide a patient an interactive healthcare media device (e.g., a portable, handheld tool) capable of, for example, receiving a healthcare report from a practitioner, enabling the patient to generate a response (e.g., an inquiry) regarding the received report and/or other type of information (e.g., lab results, biopsy summaries, etc.), communicating the response to the practitioner, opening a line of communication between the patient and the practitioner, and/or providing other functionality described in greater detail herein.

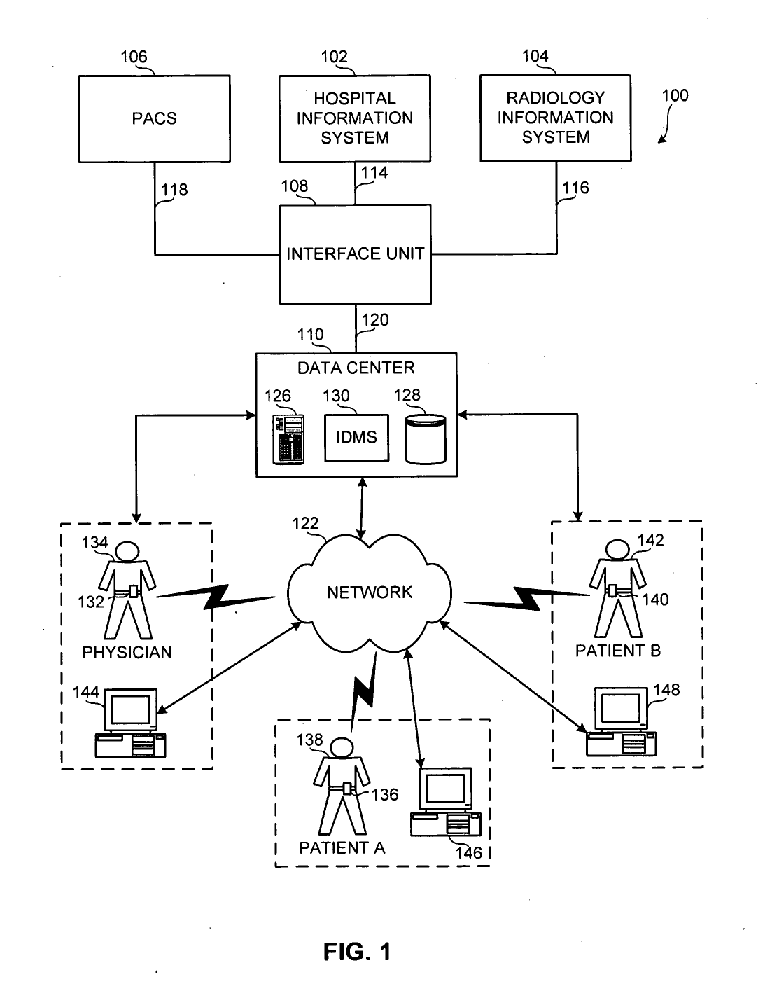

FIG. 1 is a block diagram of an example clinical information system 100 capable of implementing the example methods, apparatus, systems, and/or articles of manufacture described herein. The example clinical information system 100 includes a hospital information system (“HIS”) 102, a radiology information system (“RIS”) 104, a picture archiving and communication system (“PACS”) 106, an interface unit 108, and a data center 110. In the illustrated example, the HIS 102, the RIS 104, and the PACS 106 are housed in a healthcare facility and locally archived. However, in other implementations, the HIS 102, the RIS 104, and/or the PACS 106 may be housed one or more other suitable locations. In certain implementations, one or more of the PACS 106, RIS 104, HIS 102, etc., can be implemented remotely via a thin client and/or downloadable software solution. Furthermore, one or more components of the clinical information system 100 may be combined and/or implemented together. For example, the RIS 104 and/or the PACS 106 may be integrated with the HIS 102; the PACS 106 may be integrated with the RIS 104; and/or the three example information systems 102, 104, and/or 106 may be integrated together. In other example implementations, the clinical information system 100 includes a subset of the illustrated information systems 102, 104, and/or 106. For example, the clinical information system 100 may include only one or two of the HIS 102, the RIS 104, and/or the PACS 106. Preferably, information (e.g., scheduling, test results, observations, diagnosis, etc.) is entered into the HIS 102, the RIS 104, and/or the PACS 106 by healthcare practitioners (e.g., radiologists, physicians, and/or technicians) before and/or after patient examination.

The HIS 102 stores medical information such as clinical reports, patient information, and/or administrative information received from, for example, personnel at a hospital, clinic, and/or a physician's office. The RIS 104 stores information such as, for example, radiology reports, messages, warnings, alerts, patient scheduling information, patient demographic data, patient tracking information, and/or physician and patient status monitors. Additionally, the RIS 104 enables exam order entry (e.g., ordering an x-ray image of a patient) and image and film tracking (e.g., tracking identities of one or more people that have checked out a film). In some examples, information in the RIS 104 is formatted according to the HL-7 (Health Level Seven) clinical communication protocol.

The PACS 106 stores medical images (e.g., x-ray images, scans, three-dimensional renderings, etc.) such as, for example, digital images, image measurements, qualitative and/or quantitative results, analysis reports of image readings, etc. in a database or registry. In some examples, the medical images are stored in the PACS 106 using the Digital Imaging and Communications in Medicine (“DICOM”) format and/or any other suitable format (e.g., JPEG, PDF, etc.). Images are stored in the PACS 106 by healthcare practitioners (e.g., imaging technicians, physicians, radiologists) after a medical imaging of a patient and/or are automatically transmitted from medical imaging devices to the PACS 106 for storage. In some examples, the PACS 106 may also include a display device and/or viewing workstation to enable a healthcare practitioner to communicate with the PACS 106.

The interface unit 108 includes a hospital information system interface connection 114, a radiology information system interface connection 116, a PACS interface connection 118, and a data center interface connection 120. The interface unit 108 facilities communication among the HIS 102, the RIS 104, the PACS 106, and/or the data center 110. The interface connections 114, 116, 118, and 120 may be implemented by, for example, a Wide Area Network (“WAN”) such as a private network or the Internet. Accordingly, the interface unit 108 includes one or more communication components such as, for example, an Ethernet device, an asynchronous transfer mode (“ATM”) device, Wi-Fi device, a DSL modem, a cable modem, a cellular modem, etc. In some examples, the interface unit 108 also includes a broker (e.g., a Mitra Imaging's PACS Broker) to allow medical information and medical images to be transmitted together and stored together.

In operation, the interface unit 108 receives images, medical reports, administrative information, and/or other clinical information from the information systems 102, 104, 106 via the interface connections 114, 116, 118. If necessary (e.g., when different formats of the received information are incompatible), the interface unit 108 translates or reformats (e.g., into Structured Query Language (SQL), Extended Markup Language (XML), or standard text) the medical information, such as medical reports, to be properly stored at the data center 110. Preferably, the reformatted medical information may be transmitted using a transmission protocol to enable different medical information to share common identification elements such as, for example, a master index element, patient name, and/or social security number. Next, the interface unit 108 transmits the medical information to the data center 110 via the data center interface connection 120. Finally, medical information is stored in the data center 110 in, for example, the DICOM format, which enables medical images and corresponding medical information to be transmitted and stored together.

The example data center 110 of FIG. 1 is an archive to store information such as, for example, images, data, medical reports, and/or, more generally, patient medical records. In addition, the data center 110 may also serve as a central conduit to information located at other sources such as, for example, local archives, hospital information systems/radiology information systems (e.g., the HIS 102 and/or the RIS 104), or medical imaging/storage systems (e.g., the PACS 106 and/or connected imaging modalities). That is, the data center 110 may store links or indicators (e.g., identification numbers, patient names, or record numbers) to information. In the illustrated example, the data center 110 is managed by an application server provider (“ASP”) and is located in a centralized location that may be accessed by a plurality of systems and facilities (e.g., hospitals, clinics, doctor's offices, other medical offices, and/or terminals).

The example methods, apparatus, systems, and/or articles of manufacture described herein can be implemented on a system capable of sharing healthcare information among a plurality of healthcare enterprises (e.g., hospitals, clinics, physician offices, etc.). For example, the clinical information system 100 of FIG. 1 can implement an Integrating the Healthcare Enterprise (IHE) Cross Enterprise Document Sharing (XDS) integration profile to facilitate the sharing (e.g., registration, distribution, access, etc.) of medical data among one or more healthcare enterprises. The XDS profile includes a common set of standards or policies for the healthcare enterprises that agree to share medical data using a common infrastructure. Moreover, any additional or alternative medical data sharing system (e.g., any health information exchanges (HIES) and/or regional health information organizations (RHIOs) designed to enable a plurality of healthcare enterprises to exchange healthcare information) can be used to implement the example methods, apparatus, systems, and/or articles of manufacture described herein.

The medical information of the data center 110 and/or the other information systems (e.g., the HIS 102, the RIS 104, the PACS 106, and/or any other suitable information source) is later viewable and easily retrievable at one or more of workstations (e.g., by their common identification element, such as a patient name or record number). The workstations may be any equipment (e.g., a personal computer) capable of executing software that permits electronic data (e.g., medical reports) and/or electronic medical images (e.g., x-ray images, ultrasounds, MRI scans, etc.) to be acquired, stored, or transmitted for viewing and operation. The workstations receive commands and/or other input from a user via, for example, a keyboard, mouse, track ball, microphone, etc. The workstations are capable of implementing one or more user interfaces to enable a healthcare practitioner to interact with the clinical information system 100. Further, the workstations include one or more dedicated applications configured to operate and/or communicate with, for example, the HIS 102, the RIS 104 and/or the PACS 106. Access to such workstations for practitioners is often limited due to, for example, inadequate resources, immobility, geographic restrictions, lack of authorization, and/or other factors.

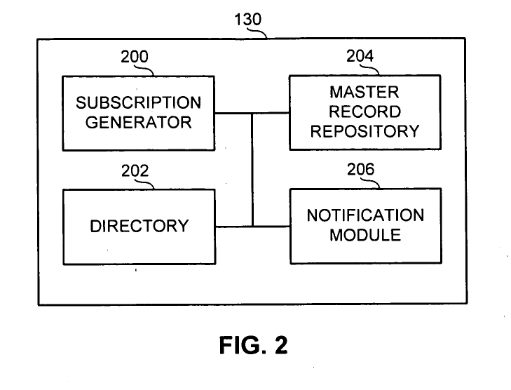

The example data center 110 of FIG. 1 includes a server 126, a database 128, and an interactive device management system (IDMS) 130. The server 126 receives, processes, and conveys information to and from the components of the clinical information system 100. The database 128 stores the medical information described herein and provides access thereto. Generally, the example IDMS 130 of FIG. 1 manages a plurality of interactive healthcare media devices described herein and some or all of the information used thereby. The example IDMS 130 is described in greater detail below in connection with FIG. 2.

The data center 110 can communicate with the workstations described above directly and/or via a network 122, implemented at a plurality of locations (e.g., a hospital, clinic, doctor's office, other medical office, or terminal, etc.). The network 122 is implemented by, for example, the Internet, an intranet, a private network, a wired or wireless Local Area Network, a wired or wireless Wide Area Network, a cellular network, and/or any other suitable network.

The example data center 110 also communicates with one or more interactive healthcare media devices using the IDMS 130. While the example IDMS 130 of FIG. 1 is implemented in the example data center 110, the IDMS 130 may be implemented in any other suitable location, device, domain, etc. The illustrated example of FIG. 1 includes a physician interactive media device 132 associated with a physician 134, a first patient interactive media device 136 associated with a first patient 138 (labeled ‘Patient A’ in the example of FIG. 1), and a second interactive media device 140 associated with a second patient 142 (labeled ‘Patient’ B in the example of FIG. 1). The example physician interactive media device 132, the example first patient interactive media device 136, and the example second patient interactive media device 140 of FIG. 1 are portable or mobile devices (e.g., personal digital assistants (PDAs), smartphones (e.g., an Apple® iPhone® or iTouch®, a Blackberry® smartphone) and/or any other portable or mobile computing devices having wired or wireless access to the network 122) capable of implementing the example methods, apparatus, systems, and/or articles of manufacture described herein. That is, the example methods, apparatus, systems, and/or articles of manufacture described herein may be integrated with one or more devices (e.g., as a software package capable of being installed and executed on a computing device) and/or may be implemented on a dedicated device. Further, the example methods, apparatus, systems, and/or articles of manufacture described can be implemented on other devices such as, for example, a physician workstation 144 (e.g., a personal computer and/or laptop computing device) associated with the physician 134, a first patient workstation 146 associated with the first patient 138, and/or a second patient workstation 148 associated with the second patient 142. The portable interactive devices 132, 136, and 140 can be coupled (e.g., via a wired and/or wireless connection) to the workstations 144, 146, and 148, respectively, to communicate therewith and/or to perform a plurality of functions related to the example methods, apparatus, systems, and/or articles of manufacture described herein. For example, the physician interactive media device 132 can be coupled to the physician workstation 144 to perform a synchronization of a record libraries stored on the respective devices. Other example functionality related to the example methods, apparatus, systems, and/or articles of manufacture is described in greater detail below.

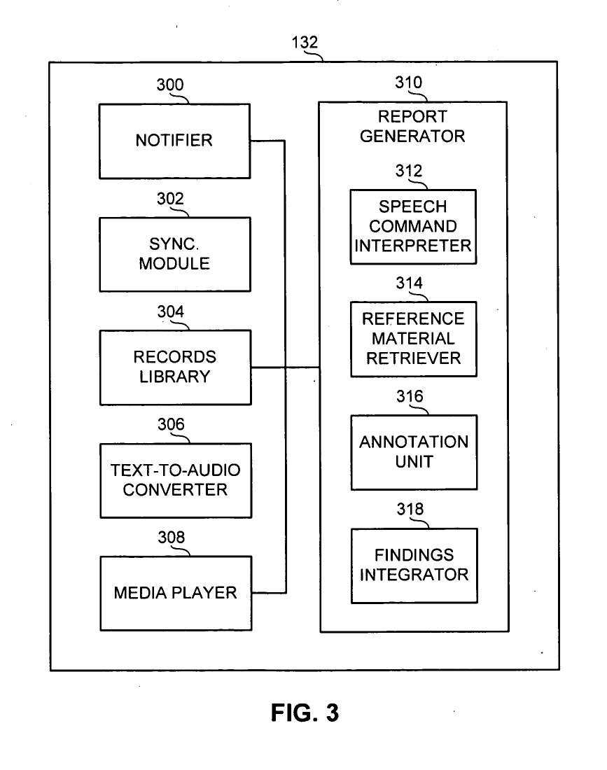

Generally, the interactive media devices 132, 136, and 140 work together and with the IDMS 130 to provide physicians and patients improved abilities to communicate, exchange information, listen to, edit, and/or generate reports and/or inquires, and/other other functions described in greater detail herein. The example physician interactive media device 132 receives (e.g., via a subscription service as described below) information from the IDMS 130 such as, for example, findings of an analysis of a healthcare image (e.g., x-ray images, ultrasounds, MRI scans, clinical reports, test results, etc.) performed by a clinician (e.g., a radiologist, cardiologist, neurologist, etc.). The example physician interactive media device 132 is configured to present a multimedia presentation of the findings to the physician 134 by pairing visual information with audio representations of, for example, text reports coded with one or more markup languages. For example, when the findings include textual information, the physician interactive media device 132 can convert the textual information to audio information that can be presented to the physician 134 in conjunction with a display of visual information (e.g., x-ray images, ultrasounds, MRI scans, clinical reports, test results, etc.) associated with the findings. Additionally, the physician interactive media device 132 is configured to enable the physician 134 to modify, add to, and/or otherwise manipulate (e.g., via voice commands) the findings to generate a report to be conveyed to the corresponding patient (e.g., the first patient 138). Thus, the physician interactive media device 132 provides a portable, hands-free review and/or modification of the findings received from a reviewing clinician and/or other information. The example physician interactive media device 132 is described in greater detail below in connection with FIG. 3.

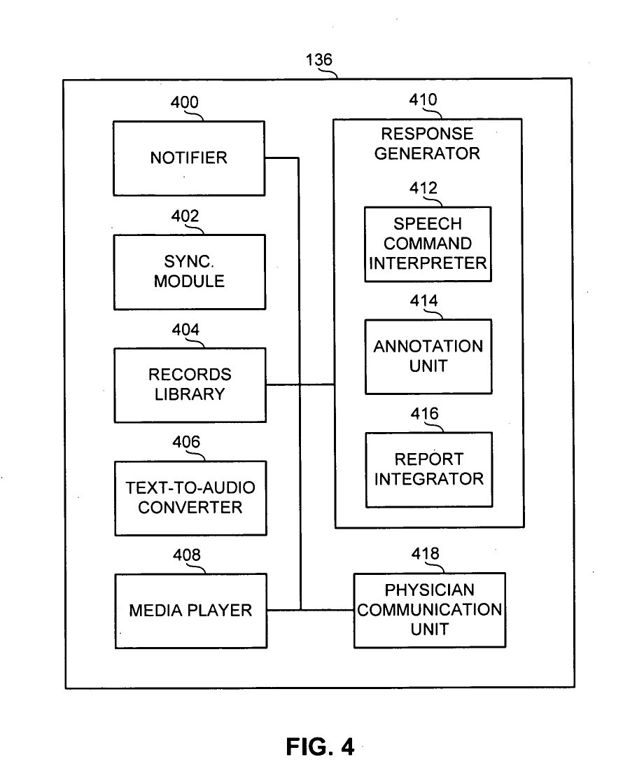

The example patient interactive media devices 136 and 138 receive (e.g., via a subscription service as described below) information from the IDMS 130 such as, for example, a report generated by the physician 134. In some examples, the patient interactive media devices 136 and 138 receive information directly from the physician 134 via, for example, the physician interactive media device 132 and/or the physician workstation 144. The example patient interactive media devices 136 and 138 are configured to present a multimedia presentation of, for example, the report generated by the physician 134 described above to the patients 138 and 142, respectively. For example, when the report generated by the physician includes textual information, the patient interactive media devices 136 and 138 receive can convert the textual information to audio information that can by presented to the patients 138 and 142, respectively, in conjunction with a display of visual information (e.g., x-ray images, ultrasounds, MRI scans, clinical reports, test results, etc.) associated with the report. Additionally, the patient interactive media devices 136 and 140 are configured to enable the patients 138 and 142 to modify, add to, and/or otherwise manipulate (e.g., via voice commands) the physician report to generate a response (e.g., an inquiry for the physician 134), which can be conveyed to the physician 134 directly and/or via the IDMS 130. The example patient interactive media devices 136 and 140 are described in greater detail below in connection with FIG. 4.

FIG. 2 is a block diagram of an example apparatus that may be used to implement the example IDMS 130 of FIG. 1. In the illustrated example of FIG. 2, the example IDMS 130 includes a subscription generator 200, a directory 202, a master record repository 204, and a notification module 206. While an example manner of implementing the IDMS 130 of FIG. 1 has been illustrated in FIG. 2, one or more of the elements, processes and/or devices illustrated in FIG. 2 may be combined, divided, re-arranged, omitted, eliminated and/or implemented in any other way. Further, the example subscription generator 200, the example directory 202, the example master record repository 204, the example notification module 206, and/or, more generally, the example IDMS 130 of FIG. 2 may be implemented by hardware, software, firmware and/or any combination of hardware, software and/or firmware. Thus, for example, any of the example subscription generator 200, the example directory 202, the example master record repository 204, the example notification module 206, and/or, more generally, the example IDMS 130 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example subscription generator 200, the example directory 202, the example master record repository 204, the example notification module 206, and/or, more generally, the example IDMS 130 of FIG. 2 are hereby expressly defined to include a tangible medium such as a memory, DVD, CD, etc., storing the software and/or firmware. Further still, the example IDMS 130 of FIG. 2 may include one or more elements, processes and/or devices in addition to, or instead of, those illustrated in FIG. 2, and/or may include more than one of any or all of the illustrated elements, processes and devices.

The example subscription generator 200 of FIG. 2 receives requests from practitioners, patients, and/or other related entities for one or more subscriptions to healthcare information. For example, the example physician 134 of FIG. 1 subscribes to healthcare information related to the example first and second patients 138 and 142. Thus, when a clinician (e.g., a radiologist) analyzes a healthcare document (e.g., an x-ray image) related to the first patient 138 and creates findings reflected the analysis, the physician 134 automatically receives the findings and/or a notification thereof via a subscription service corresponding to the example subscription generator 200. The example first and second patients 138 and 142 of FIG. 1 subscribe to healthcare information related to their respective healthcare. For example, the first patient 138 subscribes to healthcare information associated with the physician 134 and the first patient 138. Thus, when the physician 134 generates a report (e.g., based on the findings of a radiologist), the first patient 138 automatically receives the report and/or a notification thereof via the subscription service corresponding to the example subscription generator 200.

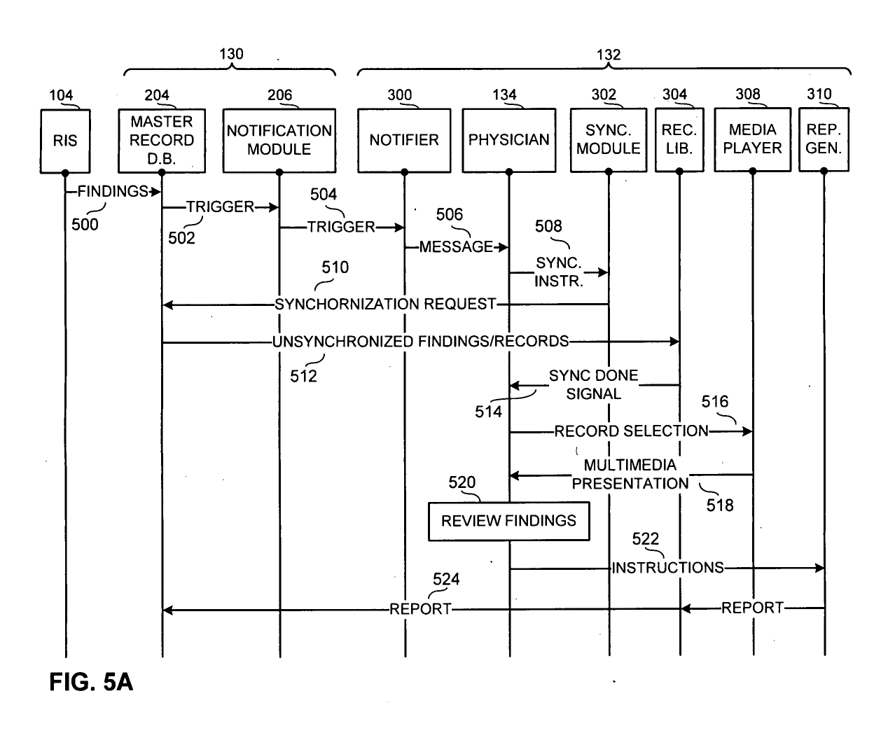

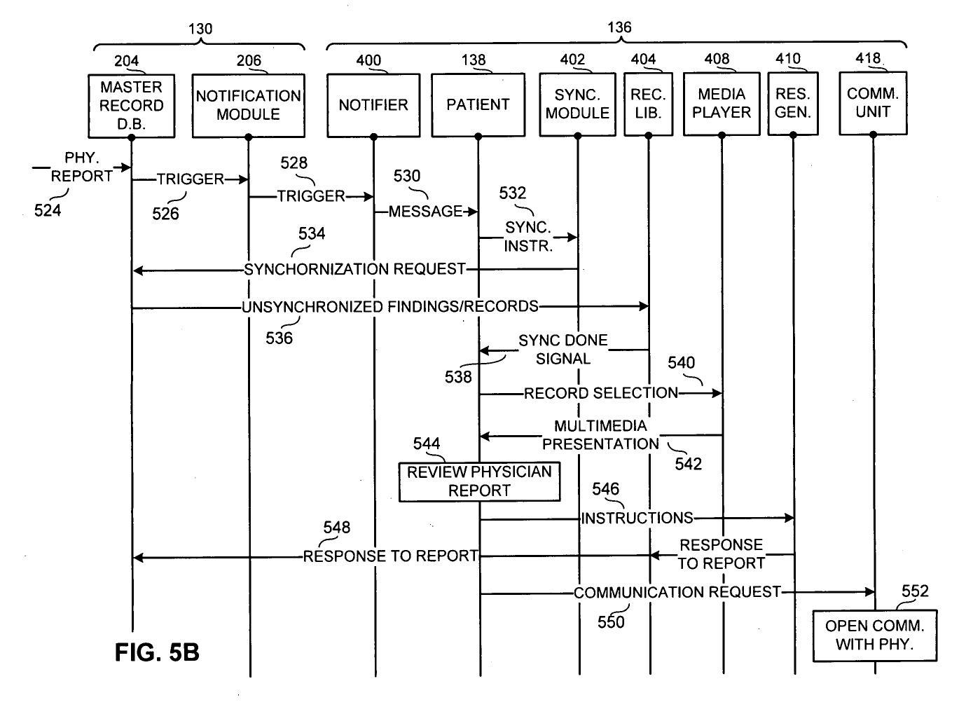

To provide these automatic information transfers, the example subscription generator 200 of FIG. 2 generates a link between the physician 134 and the patient(s) 138 and/or 142 using, for example, identifiers associated therewith. For example, the example subscription generator 200 of FIG. 1 creates an electronic data file or link to a remote data file associated with the physician 134 including one or more definitions or identifications of patients to which the physician is subscribed. The example electronic data files can be stored in the example directory 202 of FIG. 2. As a result, when a healthcare record associated with the first patient 138 is generated, released, and/or authorized (e.g., by a radiologist), the physician 134 is automatically provided with and/or made aware of the healthcare record. Further, as a result of the subscription(s) generated by the example subscription generator 200, when a healthcare record associated with first patient 138 is generated, released, and/or authorized (e.g., by the physician 134), the first patient 138 is automatically provided with and/or made aware of the healthcare record. Of course, different types of healthcare records may be made available to different entities based on access restrictions (e.g., data stored in associated with the subscriptions in the directory 202). For example, the physician 134 may receive lab results associated with the first patient 138 via a corresponding subscription that the first patient 138 will not receive upon the release of the lab results. Rather, the first patient 138 receives a report generated by the physician 134 interpreting, summarizing, and/or including the lab results. Such a workflow and/or process are described in greater detail below in connection with FIGS. 5A and 5B.

While FIG. 2 illustrates the example IDMS 130 including a subscription generator 200, the example IDMS 130 may include additional or alternative components, systems, and/or devices for communicating healthcare information to and/or from different entities. For example, the IDMS 130 may include a portal that one or more communication devices may access (e.g., using an authorization process including a user name and password) to upload and/or download healthcare information.

The example master record repository 204 stores healthcare information received from, for example, the interface unit 108, the physician interactive media device 132, the physician workstation 144, the first and/or second patient interactive media devices 136 and/or 140, the first and/or second patient workstations 146 and/or 148, and/or additional sources of healthcare information. The information stored in the example master record repository 204 of FIG. 2 is retrievable by authorized users (e.g., the physician 134, the first patient 138, the second patient 142, and/or other healthcare practitioner(s)) directly and/or via the network 122. In the illustrated example, the subscriptions stored in the directory 202 access the master record repository 204 and/or receive signals from the master record repository 204 to determine whether one or more healthcare records have recently been entered and/or authorized for release (e.g., signed by a corresponding practitioner, thereby making the record available to authorized entities, such as a designated physician). If so, the corresponding subscription of the directory 202 makes the newly entered healthcare record available to the subscribing entity and/or provides a notification to the subscribing entity of the availability of the record.

To notify the subscribing entity of the availability of one or more records, the example IDMS 130 of FIG. 2 includes the notification module 206. In some instances, one or more of the subscriptions of the directory 202 are configured to provide a notification to a subscriber (e.g., the physician 134, the first patient 136, the second patient 142, and/or any other subscriber(s)) that a healthcare record is available with or without automatically conveying the healthcare record to a device of the subscriber (e.g., the physician interactive media device 132, the first patient interactive media device 136, the second patient interactive media device 140, the physician workstation 144, the first patient workstation 146, the second patient workstation 148, and/or any other suitable device and/or workstation). In such instances, the example notification module 206 is informed of the availability of the healthcare record (e.g., by the corresponding subscription in the directory 202) and, in response, conveys a notification message to the subscriber and/or one or more devices associated with the subscriber. In the illustrated example, the notification message triggers a notifier in the corresponding device and/or workstation capable of communicating with the subscriber. As described in greater detail below, the notifier of the corresponding device may generate an electronic mail message (an email), a telephone call, a short message service (SMS) communication, a multimedia messaging service (MMS) communication, and/or any other suitable communication and convey the same to the corresponding subscriber. Additionally or alternatively, the notification module 206 of the IDMS 130 can generate such a communication directly to the subscriber without having to trigger the notifier of the respective device.

FIG. 3 is a block diagram of an example apparatus that may be used to implement the example physician interactive media device 132 of FIG. 1. In the illustrated example of FIG. 3, the example physician interactive media device 132 includes a notifier 300, a synchronization module 302, a records library 304, a text-to-audio converter 306, a media player 308, and a report generator 310 including a speech command interpreter 312, a reference material retriever 314, an annotation unit 316, and a findings integrator 318. While an example manner of implementing the physician interactive media device 132 of FIG. 3 has been illustrated in FIG. 3, one or more of the elements, processes and/or devices illustrated in FIG. 3 may be combined, divided, re-arranged, omitted, eliminated and/or implemented in any other way. Further, the example notifier 300, the example synchronization module 302, the example records library 304, the example text-to-audio converter 306, the example media player 308, the example report generator 310, the example speech command interpreter 312, the example reference material retriever 314, the example annotation unit 316, the example findings integrator 318, and/or, more generally, the example physician interactive media device 132 of FIG. 3 may be implemented by hardware, software, firmware and/or any combination of hardware, software and/or firmware. Thus, for example, any of the example notifier 300, the example synchronization module 302, the example records library 304, the example text-to-audio converter 306, the example media player 308, the example report generator 310, the example speech command interpreter 312, the example reference material retriever 314, the example annotation unit 316, the example findings integrator 318, and/or, more generally, the example physician interactive media device 132 of FIG. 3 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example notifier 300, the example synchronization module 302, the example records library 304, the example text-to-audio converter 306, the example media player 308, the example report generator 310, the example speech command interpreter 312, the example reference material retriever 314, the example annotation unit 316, the example findings integrator 318, and/or, more generally, the example physician interactive media device 132 of FIG. 3 are hereby expressly defined to include a tangible medium such as a memory, DVD, CD, etc., storing the software and/or firmware. Further still, the example physician portable device of FIG. 3 may include one or more elements, processes and/or devices in addition to, or instead of, those illustrated in FIG. 3, and/or may include more than one of any or all of the illustrated elements, processes and devices.

Generally, the example physician interactive media device 132 may be any equipment (e.g., a smartphone, a personal digital assistant, a portable or mobile device with Wi-Fi or cellular communications components or devices, etc.) capable of executing software that permits electronic data (e.g., healthcare reports) and/or electronic healthcare images and/or documents (e.g., x-ray images, ultrasounds, MRI scans, clinical reports, test results, etc.) to be acquired, stored, or transmitted for viewing and operation. The example physician interactive media device 132 receives commands and/or other input from the physician 134 via, for example, a keyboard, mouse, track ball, microphone, headset, a touchscreen, etc. The example physician interactive media device 132 includes presentation devices (e.g., a high-resolution screen, speaker(s), touch-screen devices, specialized drivers to view specific images such as x-ray images, magnetic resonance imaging (MRI) scans, etc. on a screen) capable of presenting images, video, audio, etc.

The example notifier 300 of FIG. 3 receives a signal from, for example, the notification module 206 of the IDMS 130 indicating that a healthcare record (e.g., findings associated with a reading of an x-ray image performed by a radiologist) to which the physician 134 subscribes is available. In some examples, the example notifier 300 receives one or more signals from a synchronization mechanism or component of the IDMS 130 that synchronizes a record repository with an application implemented on a computing device such as, for example, iTunes®. As described above, the healthcare record may be automatically conveyed to the physician interactive device 132 and/or a notification of the availability of the healthcare record may be conveyed to the physician 134. In response to signals received from the notification module 206 of the IDMS 130, the example notifier 300 of FIG. 3 generates a message receivable by the physician 134. For example, the example notifier 300 of FIG. 3 is configured to display a visual message on a display device of the physician interactive device 132 identifying the newly available healthcare record. Additionally or alternatively, the visual message may be displayed in conjunction with a user interface option to retrieve the identified healthcare record (e.g., via a synchronization process described herein). Further, the example notifier 300 of FIG. 3 is configured to generate an email and/or multimedia text message identifying the newly available healthcare record and to convey the email to a designated electronic address associated with the physician 134. In some examples, the physician interactive device 132 is capable of accessing an inbox associated with the designated electronic address and informing the physician 134 of an unread email in the inbox (e.g., via an audible prompt). The example notifier 300 of FIG. 300 may be configured to notify the physician 134 of any newly available healthcare record(s) in any additional or alternative manner.

The example synchronization module 302 of FIG. 3 is configured to synchronize the contents of the example records library 304 of the physician interactive device 132 with contents of the master record repository 204 of the IDMS 130 that are associated with the physician 134. Further, because the physician workstation 144 may include a local record library (not shown) separate from the record library 304 of the corresponding physician device 132, the example synchronization module 302 of FIG. 3 is also configured to synchronize the contents of the example records library 304 of the device 132 with the contents of any local library of healthcare information stored on the physician workstation 144. In the illustrated example, the example records library 304 is a local electronic collection of healthcare records related to the physician 134. The physician interactive device 132 implements a user interface (e.g., Apple® iPhoto®, Adobe® Photoshop® for a mobile device) to enable the physician 134 to navigate, manipulate, and/or otherwise interact with the records library 304. The example synchronization module 302 can be set to automatically perform synchronization in response to receiving a message from the notification module 206 of the IDMS 130 or to prompt the physician 134 and wait for instructions to perform the synchronization in response to receiving the message from the notification module 206.

The example text-to-audio converter 306 of FIG. 3 is to provide the physician 134 an option to listen to an audio version of one or more healthcare records stored in the records library 304. In the illustrated example of FIG. 3, the text-to-audio converter 306 is triggered in response to a healthcare record arriving at the records library 304. The healthcare record, such as a textual representation of findings created by a radiologist corresponding to a reading of an x-ray image, is converted to audio file (e.g., a WAV file, an MP3 file, an MP4 file, etc.) that can be played by the physician interactive device 132. In the illustrated example, the audio file is stored in the records library 304 in association with the corresponding healthcare record. In some examples, the audio file may be conveyed to one or more other memories such as, for example, the data center 110, the master record repository 204 of the IDMS 130, and/or any other suitable storage device.

The example media player 308 of FIG. 3 facilitates a presentation of the healthcare record(s) stored in the records library 304 in response to, for example, a selection of the healthcare record(s) from a user interface by the physician 134. In the illustrated example, the media player 308 retrieves a visual representation of the healthcare record (e.g., a textual document such as a Microsoft® Word® file, a coded information document such as an XML document or structure, reports including quantitative and/or qualitative information related to a healthcare record, a digital image of an x-ray image, MRI scan, cardiology image, ultrasound Doppler, pathology reports, etc.) and any corresponding audio files. Further, the example media player 308 presents the visual representation of the healthcare record concurrently with any corresponding audio files. The example media player 308 implements a user interface to enable the physician 134 to navigate, manipulate, and/or otherwise explore the visual and/or audio representation of the healthcare record. For example, the physician 134 may scroll through text, reposition an image, pause/fast-forward/rewind a slideshow of images, pause/fast-forward/rewind an audio file (and, concurrently the slideshow corresponding to the audio file) using a tactile device such as a button, control wheel, mouse pad, etc., and/or voice commands that can be interpreted by the media player 308.

The example report generator 310 of FIG. 3 enables the physician 134 to generate a report to be conveyed to the patient 136 and/or any other subscribing entity (e.g., a relative of the patient 136, such as a spouse or parent). The example report generator 310 of FIG. 3 includes a plurality of tools to facilitate the creation of the report by, for example, enabling the physician 134 to modify, add to, and/or otherwise manipulate the findings received from the IDMS 130. That is, when the physician 134 receives the findings from, for example, a radiologist reviewing an x-ray image, the physician 134 may desire to edit the findings to make the resulting report more understandable to the patient 138 and/or any other subscribing entity. Furthermore, the physician 134 may desire to supplement the findings with additional or alternative information, as described below in connection with the example annotation unit 316, the example reference material retriever 314, and/or the example findings integrator 318. When the physician 134 approves of the report (e.g., by electronically signing and/or otherwise authorizing the report for release), the report generator 310 conveys the report to the IDMS 130. As described herein, the patient 138 can then receive the report via the subscriptions stored in the directory 202 and/or the notification module 206.

To enable the physician 134 to create the report and/or other documentation and/or provide other instructions using his or her voice, the example report generator 310 includes the speech command interpreter 312. The example speech command interpreter 312 receives voice data (e.g., commands) and is capable of interpreting the same. For example, the speech command interpreter 312 of FIG. 3 includes a library of commands words recognizable by the speech command interpreter 312 (e.g., regardless of the speech characteristics of the speaker). Example commands includes those dedicated to navigating the visual and/or audio healthcare information, those dedicated to generating the report to be conveyed to the patient 138, those dedicated to adding or editing information from the original document, those dedicated to enable image display manipulation, those dedicated to requesting additional automated analysis of the image, those dedicated to inquiring into additional information about the healthcare records associated with a patient, etc.

The example reference material retriever 314 of FIG. 3 enables the physician 134 to modify the findings and/or the report by adding reference material thought useful by the physician 134 in explaining the diagnosis and/or medical situation to the patient 134. The example reference material retriever 314 receives commands from the physician 134 (e.g., via a tactile device and/or voice commands) to acquire external information related to, for example, a medical condition involved in the findings and/or the physician report. Such information may be used by the patient 138 in comprehending the physician report. The reference material retriever 314 can obtain the desired reference material from a dedicated source (e.g., a source of reference medical information stored at the data center 110) and/or any other source including reliable information (e.g., a file server accessible via the network 122 designated by the physician 134 in the command to retrieve the reference information and/or in a default or customizable setting of the interactive device 132).

The example annotation unit 316 of FIG. 3 enables the physician 134 to annotate the findings received from the reviewing practitioner (e.g., a radiologist) such that the findings are more understandable for the patient 138. That is, the physician 134 can include explanation(s) in, for example, a foot note inserted into the report by the annotation unit 316. The example annotation unit 316 receives commands from the physician 134 (e.g., via a tactile device and/or voice commands) to annotate the report. The annotations can be dictated to the interactive media device 132 and transcribed (e.g., via the media device 132 and/or an external transcription service) into and/or as an attachment to the report.

The annotations and/or any other information inserted into the report can be implemented as one or more hyperlinks that represent a source of information (e.g., an educational source of reference material obtained by the reference material retriever 314) and/or another aspect of the report (e.g., another image and/or another area of an image). The hyperlinks can be engaged to navigate to the information source and/or the other aspect of the report. In the illustrated example, the annotation unit 316 stores the information to implement the hyperlink (e.g., a source address or a document map address). However, such information can be stored in any suitable location and/or by any suitable device.

In some examples, the annotation unit 316 of FIG. 3 also enables a recording of the annotative actions of the physician 134. For example, as the physician 134 parses through the findings and analyzes the same, the annotation unit 316 records gestures made by the physician 134 on the screen of the physician interactive device 132 (e.g., when the device 132 includes a touchscreen, such as an iPhone®). As an illustration, when the physician 134 touches the screen of the interactive device 132 in a location of an image indicative of a symptom and/or pathology to add an annotation or comment, the annotation unit 316 stores the location at which the physician 134 touched the screen. Later, when the physician report is played back as a multimedia presentation (e.g., to a patient), a video aspect of the presentation includes a pointer (e.g., a hand icon) located on the stored location of the image. Additionally, the audio representation of the annotation or comment corresponding to the recorded gesture is presented at a substantially similar time as the pointer being moved to the recorded location of the image. This enables a consumer of the presentation to follow the sequence of thought expressed by the physician 134 in reviewing and analyzing the image.

The example findings integrator 318 of FIG. 3 enables the physician 134 to integrate information from the findings generated by the reviewing practitioner (e.g., a radiologist) into the report to be conveyed to the patient 138. For example, the findings integrator 318 of FIG. 3 facilitates a copy-paste function capable of selecting one or more portions of textual information and/or image(s) for insertion into the report to be conveyed to the patient 138. Other fields of information from the findings, such as the reasons the corresponding analysis was ordered, may be integrated into the report via the findings integrator 318. That is, the example findings integrator 318 provides the physician 134 the option to (e.g., automatically by a default or customized setting) to include variable information that occupy dedicated fields in the findings.

FIG. 4 is a block diagram of an example apparatus that may be used to implement the first example patient interactive media device 136 of FIG. 1. The second example patient interactive media device 140 associated with the second patient 142 is substantially similar to the first example patient interactive media device 136 associated with the first patient, but is not described in detail herein for purposes of brevity. In the illustrated example of FIG. 4, the example patient interactive media device 136 includes a notifier 400, a synchronization module 402, a records library 404, a text-to-audio converter 406, a media player 408, a response generator 410 including a speech command interpreter 412, an annotation unit 414, and a report integrator 416, and a physician communication unit 418. While an example manner of implementing the patient interactive media device 136 of FIG. 1 has been illustrated in FIG. 4, one or more of the elements, processes and/or devices illustrated in FIG. 4 may be combined, divided, re-arranged, omitted, eliminated and/or implemented in any other way. Further, the example notifier 400, the example synchronization module 402, the example records library 404, the example text-to-audio converter 406, the example media player 408, the example response generator 410, the example speech command interpreter 412, the example annotation unit 414, the example report integrator 416, the example physician communication unit 418, and/or, more generally, the example patient interactive media device 136 of FIG. 4 may be implemented by hardware, software, firmware and/or any combination of hardware, software and/or firmware. Thus, for example, any of the example notifier 400, the example synchronization module 402, the example records library 404, the example text-to-audio converter 406, the example media player 408, the example response generator 410, the example speech command interpreter 412, the example annotation unit 414, the example report integrator 416, the example physician communication unit 418, and/or, more generally, the example patient interactive media device 136 of FIG. 4 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example notifier 400, the example synchronization module 402, the example records library 404, the example text-to-audio converter 406, the example media player 408, the example response generator 410, the example speech command interpreter 412, the example annotation unit 414, the example report integrator 416, the example physician communication unit 418, and/or, more generally, the example patient interactive media device 136 of FIG. 4 are hereby expressly defined to include a tangible medium such as a memory, DVD, CD, etc., storing the software and/or firmware. Further still, the example patient portable device of FIG. 4 may include one or more elements, processes and/or devices in addition to, or instead of, those illustrated in FIG. 4, and/or may include more than one of any or all of the illustrated elements, processes and devices.

Similar to the physician interactive media device 132, the example patient interactive media device 136 may be any equipment (e.g., a smartphone, personal digital assistant, mobile internet device with Wi-Fi or cellular devices or components, etc.) capable of executing software that permits electronic data (e.g., healthcare reports) and/or electronic healthcare images (e.g., x-ray images, ultrasounds, MRI scans, clinical reports, test results, medical history records, etc.) to be acquired, stored, or transmitted for viewing and operation. The example patient interactive media device 136 receives commands and/or other input from the patient 138 via, for example, a keyboard, mouse, track ball, microphone, etc. The example patient interactive media device 136 includes presentation devices (e.g., a high-resolution screen, speaker(s), touch-screen devices, specialized drivers to view specific images such as x-ray images, magnetic resonance imaging (MRI) scans, etc. on a screen) capable of presenting images, video, audio, etc.

The example notifier 400 of FIG. 4 operates substantially similarly to the notifier 300 of FIG. 3. That is, the example notifier 400 of FIG. 4 receives a signal from, for example, the notification module 206 of the IDMS 130 indicating that a healthcare record (e.g., a report generated and authorized by the physician 134 based on findings associated with a reading of an x-ray image performed by a radiologist) to which the patient 138 subscribes is available. As described above, the healthcare record may be automatically conveyed to the patient interactive device 136 and/or a notification of the availability of the healthcare record may be conveyed to the patient 138. In response to signals received from the notification module 206 of the IDMS 130, the example notifier 400 of FIG. 4 generates a message receivable by the patient 138. For example, the example notifier 400 of FIG. 4 is configured to display a visual message on a display device of the patient interactive device 136 identifying the newly available healthcare record. Additionally or alternatively, the visual message may be displayed in conjunction with a user interface option to retrieve the identified healthcare record (e.g., via a synchronization process described herein). Further, the example notifier 400 of FIG. 4 is configured to generate an email identifying the newly available healthcare record and to convey the email to a designated electronic address associated with the patient 138. In some examples, the patient interactive device 136 is capable of accessing an inbox associated with the designated electronic address and informing the patient 138 of an unread email in the inbox (e.g., via an audible prompt). The example notifier 400 of FIG. 400 may be configured to notify the patient 138 of any newly available healthcare record(s) in any additional or alternative manner.

The example synchronization module 402 of FIG. 4, operates substantially similarly to the example synchronization module 302 of FIG. 3. That is, the example synchronization module 402 of FIG. 4 is configured to synchronize the contents of the example records library 404 of the patient interactive device 136 with contents of the master record repository 204 of the IDMS 130 that are associated with the patient 138. Further, because the patient workstation 146 may include a local record library (not shown) separate from the record library 404 of the corresponding patient device 136, the example synchronization module 402 of FIG. 4 is also configured to synchronize the contents of the example records library 404 of the device 136 with the contents of any local library of healthcare information stored on the physician workstation 146. In the illustrated example, the example records library 404 is a local electronic collection of healthcare records related to the patient 138. The patient interactive device 136 implements a user interface (e.g., Apple® iPhoto®) to enable the patient 138 to navigate, manipulate, and/or otherwise interact with the records library 404. The example synchronization module 402 can be set to automatically perform synchronization in response to receiving a message from the notification module 206 of the IDMS 130 or to prompt the patient 138 and wait for instructions to perform the synchronization in response to receiving the message from the notification module 206.

The example text-to-audio converter 406 of FIG. 4 operates substantially similarly to the example text-to-audio converter 306 of FIG. 3. That is, the example text-to-audio converter 406 of FIG. 4 is to provide the patient 138 an option to listen to an audio version of one or more healthcare records stored in the records library 404. In the illustrated example of FIG. 4, the text-to-audio converter 406 is triggered in response to a healthcare record arriving at the records library 404. The healthcare record, such as a textual representation of a report created by the physician 134 corresponding to findings of a reading of an x-ray image, is converted to audio file (e.g., a WAV file, an MP3 file, an MP4 file, etc.) that can be played by the patient interactive device 136. In the illustrated example, the audio file is stored in the records library 404 in association with the corresponding healthcare record. In some examples, the audio file may be conveyed to one or more other memories such as, for example, the data center 110, the master record repository 204 of the IDMS 130, and/or any other suitable storage device.

The example media player 408 of FIG. 4 operates substantially similarly to the example media player 308 of FIG. 3. That is, the example media player 408 of FIG. 4 facilitates a presentation of the healthcare record(s) stored in the records library 404 in response to, for example, a selection of the healthcare record(s) from a user interface by the patient 138. In the illustrated example, the media player 408 retrieves a visual representation of the healthcare record (e.g., a textual document such as a Microsoft® Word® file, PDF document, XML document or structure such as a DICOM file, a digital image of an x-ray image, MRI scan, cardiology image, etc.) and any corresponding audio files. Further, the example media player 408 presents the visual representation of the healthcare record concurrently with any corresponding audio files. The example media player 408 implements a user interface to enable the patient 138 to navigate, manipulate, and/or otherwise explore the visual and/or audio representation of the healthcare record. For example, the patient 138 may scroll through text, reposition an image, pause/fast-forward/rewind a slideshow of images, pause/fast-forward/rewind an audio file (and, concurrently the slideshow corresponding to the audio file) using a tactile device such as a button, control wheel, mouse pad, etc., and/or voice commands that can be interpreted by the media player 408.

The example response generator 410 of FIG. 4 enables the patient 138 to review the contents of the records library 404 and to generate a response (e.g., an inquiry for the physician 134) using the corresponding healthcare record. The example response generator 410 of FIG. 4 includes a plurality of tools to facilitate the creation of the response by, for example, enabling the patient 138 to modify, add to, and/or otherwise manipulate, for example, the report received from the physician 134 via the example IDMS 130. That is, when the patient 138 receives the physician report on, for example, the results of a test, scan, and/or any other type of procedure, the patient 138 may desire to edit the report to create one or more questions or comments to be posed to the physician 134. As described above, communication with the physician is often limited, especially when a transfer of electronic records is involved. Therefore, the example patient interactive device 136 of FIG. 4 enables the patient 138 to express one or more concerns and/or pose one or more questions to the physician 138 using an electronic system as well. When the patient 138 approves of the response (e.g., by electronically signing and/or otherwise authorizing the report for release), the response generator 410 conveys the response to the IDMS 130. As described herein, the physician 134 can then receive the response via the subscriptions stored in the directory 202 and/or the notification module 206.

To enable the patient 138 to create the response and/or other documentation and/or provide other instructions using his or her voice, the response generator 410 includes the speech command interpreter 412. The example speech command interpreter 412 receives voice commands and is capable of interpreting the same. For example, the speech command interpreter 412 of FIG. 4 includes a library of commands words recognizable by the speech command interpreter 412 (e.g., regardless of the speech characteristics of the speaker). Example commands includes those dedicated to navigating the visual and/or audio healthcare information and those dedicated to generating the response to be conveyed to the physician 134, those dedicated to adding or editing information from the original record(s), those dedicated to requesting additional automated analysis of the healthcare image or report, those dedicated to inquiring into additional information about the healthcare records of the patient 138, those dedicated to retrieving and/or obtaining educational and pathologically specific information (e.g., from an Internet source), etc.

The example annotation unit 414 of FIG. 4 enables the patient 138 to annotate the report received from the physician 134 such that the patient 138 can express one or more questions or concerns in the context of the report. That is, the patient 138 can include comment(s) in, for example, a foot note inserted into the response by the annotation unit 414. The example annotation unit 414 receives commands from the physician 134 (e.g., via a tactile device and/or voice commands) to annotate the report. The annotations can be dictated to the interactive media device 136 and transcribed (e.g., via the media device 136 and/or an external transcription service) into and/or as an attachment to the report.

The annotations and/or any other information inserted into the report can be implemented as one or more hyperlinks that represent a source of information (e.g., an educational source of reference material) and/or another aspect of the report (e.g., another image and/or another area of an image). The hyperlinks can be engaged to navigate to the information source and/or the other aspect of the report. In the illustrated example, the annotation unit 316 stores the information to implement the hyperlink (e.g., a source address or a document map address).

Additionally, as described above in connection with the physician interactive device 132, the example annotation unit 414 can record one or more gestures of the patient 138 in association with one or more annotations or comments. The recorded gestures are played back (e.g., to the physician 134) at a later time as part of a multimedia presentation reflecting the thoughts and/or inquires of the patient 138.

The example report integrator 416 of FIG. 4 enables the patient 138 to integrate information from the report generated by the physician 134 into the response to be conveyed to the physician 134. For example, the report integrator 416 of FIG. 4 facilitates a copy-paste function capable of selecting one or more portions of textual information and/or image(s) for insertion into the response to be conveyed to the physician 134. Other fields of information from the physician report, such as the reasons the corresponding analysis was ordered, may be integrated into the response by the report integrator 416. That is, the example report integrator 416 provides the patient 138 the option to (e.g., automatically by a default or customized setting) to include variable information that occupy dedicated fields in the report.

The example physician communication unit 418 of FIG. 4 opens a communication between the patient 138 and the physician 134. In the illustrated example, the physician communication unit 418 implements a user interface element that prompts the patient 138 to contact the physician 134 after and/or while the patient is reviewing a healthcare record (e.g., via the media player 408) and/or at any other suitable moment. When the patient 138 elects to contact the physician 134, the example physician communication unit 418 provides the patient 138 one or more options. For example, the physician communication unit 418 of FIG. 4 prompts the patient 138 to instruct the patient interactive media device 136 to dial a telephone number associated with the physician interactive media device 132. Further, the example physician communication unit 418 of FIG. 4 prompts the patient 138 compose a text message (e.g., a SMS file, a MMS file, and/or a file of another suitable protocol) to be conveyed to an electronic address associated with the physician interactive media device 132 by the patient interactive media device 136. Further, the example physician communication unit 418 of FIG. 4 prompts the patient 138 to compose an email to be conveyed to one or more email addresses associated with the physician 134. The example physician communication unit 418 of the example patient interactive media device 136 can open any other suitable type or amount of communication with the physician 134, the physician interactive media device 132, and/or the physician workstation 144.

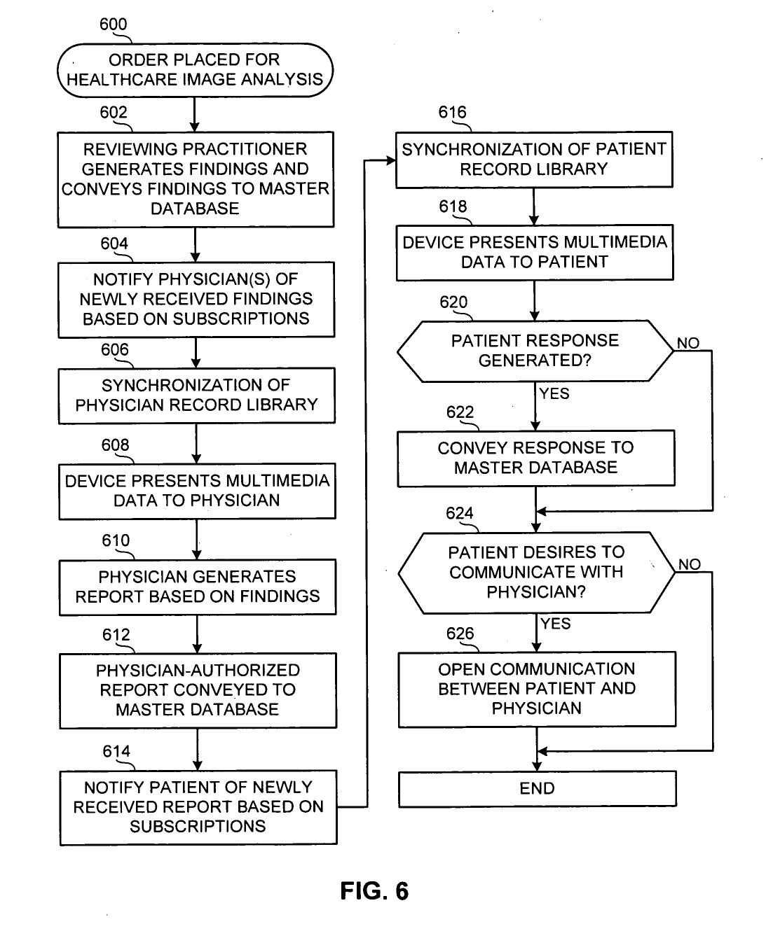

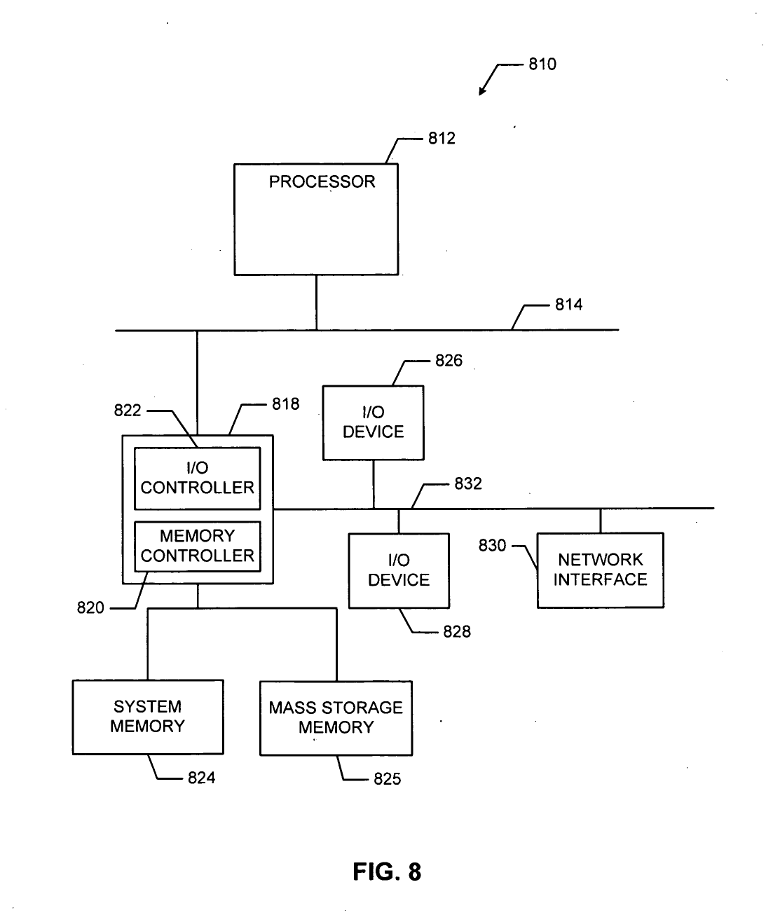

The sequence diagrams depicted in FIGS. 5A and 5B and the flow diagram depicted in FIG. 6 are representative of machine readable instructions that can be executed to implement the example interactive healthcare devices and systems of FIGS. 1, 2, 3, and/or 4. The example processes of FIGS. 5A, 5B, and/or 6 may be performed using a processor, a controller and/or any other suitable processing device. For example, the example processes of FIGS. 5A, 5B, and/or 6 may be implemented in coded instructions stored on a tangible medium such as a flash memory, a read-only memory (ROM) and/or random-access memory (RAM) associated with a processor (e.g., the example processor 812 discussed below in connection with FIG. 8). Alternatively, some or all of the example processes of FIGS. 5A, 5B, and/or 6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 5A, 5B, and/or 6 may be implemented manually or as any combination(s) of any of the foregoing techniques, for example, any combination of firmware, software, discrete logic and/or hardware. Further, although the example processes of FIGS. 5A, 5B, and/or 6 are described with reference to the sequence diagrams of FIGS. 5A and 5B and the flow diagram of FIG. 6, other methods of implementing the processes of FIGS. 5A, 5B, and/or 6 may be employed. For example, the order of execution of the blocks may be changed, and/or some of the blocks described may be changed, eliminated, sub-divided, or combined. Additionally, any or all of the example processes of FIGS. 5A, 5B, and/or 6 may be performed sequentially and/or in parallel by, for example, separate processing threads, processors, devices, discrete logic, circuits, etc.

FIG. 5A is a sequence diagram representing machine readable instructions that may be executed to implement example components of the example healthcare information system of FIGS. 1, 2, 3, and/or 4. In particular, the example sequence diagram of FIG. 5 depicts a workflow involving the RIS 104 (FIG. 1), the example IDMS 130 (FIGS. 1 and/or 2), and the example physician interactive media device 132 (FIGS. 1 and/or 3). While the example sequence diagrams of FIGS. 5A and 5B describe a sequence involving the RIS 104, an x-ray image, and a radiologist, any other modality, discipline, practitioner, and/or area of healthcare is applicable to the example methods, apparatus, systems, and/or articles of manufacture described herein.

When the physician 134 orders an analysis of, for example, an imaging procedure involving the patient 138, a radiologist obtains and reviews the images. The radiologist then records his or her findings 500 such that the physician 134 can review the same. In the illustrated example, the radiologist stores the findings 500 in the RIS 104. As described above, contents of the RIS 104 are accessible and retrievable by the data center 110 and/or, more specifically, the example IDMS 130 of FIG. 1. Thus, the example sequence diagram of FIG. 5A depicts the findings 500 of the radiologist being conveyed to the master record repository 204 of the example IDMS 130. In turn, the master record repository 204 conveys a trigger 502 to the notification module 206 of the IDMS 130 indicating that a healthcare record (e.g., the findings 500) has been entered into the master record repository 204. In the illustrated example, the trigger 502 is conveyed in association with an identifier associated with the newly entered healthcare records (e.g., the findings 500).

In the illustrated example, the notification module 206 conveys a trigger 504 to the notifier 300 of the example physician interactive device 132. The notifier 300 presents a message 506 to the physician 134 that the findings 500 are available. As described above, in some examples, the findings 500 are automatically conveyed to the physician interactive device 132. In the example of FIG. 5A the physician 134 instructs the physician interactive device 132 to synchronize the record library 304 with the contents of the master record repository 204 associated with the physician 134 (e.g., as identified by the subscriptions stored in the directory 202) using a synchronization instruction 508 (e.g., an input made available to the physician 134 via a user interface). In turn, the example synchronization module 302 conveys a synchronization request 510 to the master record repository 204. Any unsynchronized findings and/or records 512 (and/or any other type of record present in the master record repository 204 but not in the record library 304 of the physician interactive device 132) are conveyed to the record library 304 of the physician interactive device 132. In some examples, the unsynchronized findings and/or other records 512 are also conveyed to the physician workstation 144. In such instances, the synchronization module 302 can synchronize the information on the workstation 144 with the record library 304 of the interactive media device 132 when the interactive media device 132 is coupled (e.g., via a WiFi, cellular, and/or wired connection) to the workstation 144.

When the record library 304 is synced, the record library 304 conveys a signal 514 (e.g., an audio and/or visual message) to the physician 134 indicating that any newly available healthcare records (e.g., the findings 500) are locally stored and ready for presentation. In the illustrated example, the media player 308 implements a user interface that enables the physician 134 to select one or more healthcare records for presentation on the physician interactive media device 132. When the physician makes a selection, a selection signal 516 is conveyed to the media player 308 instructing the media player 308 to present the selected material. As described above, the material may be a multimedia presentation (e.g., using the text-to-audio converter 306) of healthcare information related to and/or including the findings 500. The physician 134 performs a review 520 of the findings 500 and sends instructions 522 to the report generator 310 to generate a report 524 to be conveyed to the patient 138. In the illustrated example, the instructions 522 include, for example, voice commands received and interpreted by the speech command interpreter 312, requests to retrieve and insert reference material received and addressed by the reference material retriever 314, annotation instructions received and addressed by the annotation unit 316, and/or instructions to integrate one or more portions of the findings 500 into the report 524 to be conveyed to the patient 138. These components of the report generator 310 enable such instructions to be implemented to generate the report 524 as described above in connection with FIG. 3. In the illustrated example, the resulting report 524 is conveyed to the master record repository 204, where the report 524 is accessible and retrievable by other components of the system described herein (e.g., one or more of the patient interactive media devices 136 and/or 140). Further, the example report 524 of FIG. 5A is conveyed to the record library 304 of the physician interactive media device 132 for local storage.

FIG. 5B is a sequence diagram representing machine readable instructions that may be executed to implement example components of the example healthcare information system of FIGS. 1, 2, 3, and/or 4. In particular, the example sequence diagram of FIG. 5B depicts a workflow involving, for example, the example IDMS 130 and the first example patient interactive media device 136. As described above in connection with FIG. 5A, the physician 134 generates a report 524 to be conveyed to the patient 138 based on findings 500 of, for example, a radiologist. To continue the example sequence diagram of FIG. 5A, the report 524 is shown in the example sequence diagram of FIG. 5B as being conveyed to the master record repository 204 of the example IDMS 130.

In response to receiving a new healthcare record (e.g., the physician report 524), the master record repository 204 conveys a trigger 526 to the notification module 206 of the IDMS 130 indicating that a healthcare record (e.g., the physician report 524) has been entered into the master record repository 204. In the illustrated example, the trigger 526 is conveyed in association with an identifier associated with the newly entered healthcare records (e.g., the physician report 524). In the illustrated example, the notification module 206 conveys a trigger 528 to the notifier 400 of the example patient interactive device 136. The notifier 400 presents a message 530 to the patient 138 that the report 524 is available. As described above, in some examples, the report 524 is automatically conveyed to the patient interactive device 136. In the example of FIG. 5B the patient 138 instructs the patient interactive device 136 to synchronize the record library 404 with the contents of the master record repository 204 associated with the patient 138 (e.g., as identified by the subscriptions stored in the directory 202) using a synchronization instruction 532 (e.g., an input made available to the patient 138 via a user interface).

In turn, the example synchronization module 402 conveys a synchronization request 534 to the master record repository 204. Any unsynchronized findings and/or records 536 (and/or any other type of record present in the master record repository 204 but not in the record library 404 of the patient interactive device 136) are conveyed to the record library 404 of the patient interactive device 136. In some examples, the unsynchronized findings and/or other records 536 are also conveyed to the patient workstation 146. In such instances, the synchronization module 402 can synchronize the information on the workstation 146 with the record library 404 of the interactive media device 136 when the interactive media device 136 is coupled (e.g., via a WiFi, cellular, and/or wired connection) to the workstation 146.

Additionally or alternatively, the synchronization module 402 may convey the synchronization request 534 directly to the physician interactive device 132. In such instances, the synchronization module 402 of the patient interactive device 136 requests information related to the patient 138 (e.g., as indicated by an electronic tag or label) from the record library 304 of the physician interactive device 132. In response, the example record library 304 of the physician interactive device 132 forwards any information related to the patient 138 to the patient interactive device 136 (e.g., via any suitable communication mechanisms such as cellular telephone modules) and the information is stored in the record library 404 of the patient interactive device 136.

When the record library 404 is synced, the record library 402 conveys a signal 538 (e.g., an audio and/or visual message) to the patient 138 indicating that any newly available healthcare records (e.g., the physician report 524) are locally stored and ready for presentation. In the illustrated example, the media player 408 implements a user interface that enables the patient 138 to select one or more healthcare records for presentation on the patient interactive media device 136. When the patient 138 makes a selection, a selection signal 540 is conveyed to the media player 408 instructing the media player 408 to present the selected material. As described above, the material may be a multimedia presentation (e.g., using the text-to-audio converter 406) of healthcare information related to and/or including the physician report 524.

In the illustrated example, the patient 138 performs a review 544 of the physician report 524 and sends instructions 546 to the response generator 410 to generate a response to the report 548 to be conveyed to the physician 134, which may be an inquiry regarding the contents of the physician report 524 as described above. In the illustrated example, the instructions 546 include, for example, voice commands received and interpreted by the speech command interpreter 412, annotation instructions received and addressed by the annotation unit 414, and/or instructions to integrate one or more portions of the physician report 524 into the response 548 to be conveyed to the physician 134. These components of the response generator 410 enable such instructions to be implemented to generate the response 548 (e.g., an inquiry) as described above in connection with FIG. 3. In the illustrated example, the response 548 is conveyed to the master record repository 204, where the report 524 is accessible and retrievable by other components of the system described herein (e.g., the physician interactive media device 132). Further, the example response 548 of FIG. 5B is conveyed to the record library 404 of the patient interactive media device 136 for local storage.

In the illustrated example, the patient 138 also conveys a communication request to the physician communication unit 418. In response, the physician communication unit 418 opens and/or conveys a communication with the physician 138 as described above in connection with FIG. 4.

FIG. 6 is a flow diagram representative of example machine readable instructions that may be executed to implement example components of the example healthcare information system of FIGS. 1, 2, 3, and/or 4. In the illustrated example, the physician 134 places an order for an analysis of a healthcare image (block 600). The image is to be reviewed by a practitioner specializing in the field corresponding to the image and/or analysis requested by the physician 134. As described above, the reviewing practitioner generates findings and conveys the same to the master record repository 204 (block 602). The findings of the illustrated example include a textual representative of the reviewing practitioner diagnosis, observations, etc. In response to the arrival of the healthcare record in the master record repository 204, the notification module 206 facilitates a notification to be conveyed to the physician 134 (block 604). As described above, the notification module 206 of the example IDMS 130 cooperates with the notifier 300 of the example physician interactive media device 132 and/or the physician workstation 144 to create and present a notification to the physician 134 regarding the availability of the findings of the reviewing practitioner.

In the illustrated example, the physician 134 is prompted regarding the newly available findings. In response, the physician 134 instructs the synchronization module 302 of the physician interactive media device 132 to synchronize the record library 304 thereof with the master record repository 204 of the example IDMS 130. The synchronization module 302 exchanges information with the master record repository 204 such that the record(s) available in the master record repository 204 associated with the physician 134 (e.g., including the newly generated findings of the reviewing practitioner described above in connection with block 602) are available (e.g., stored on) in the record library 304 (block 606). The records associated with the physician 134 can be determined by referencing the subscriptions stored in the example directory 202 of the example IDMS 130.

When the findings of the reviewing practitioner are available in the record library 304, the physician 134 is able to select the same for presentation. As described above, if possible given the format of the findings, the findings and/or portion(s) thereof are converted to an audio file capable of being presented in conjunction with the visual information associated with the findings and/or the healthcare information on which the findings are based. Therefore, in the illustrated example, when the physician 134 selects the findings for presentation, the media player 308 of the example physician interactive media device 132 presents a multimedia (e.g., a visual and/or audio presentation) presentation of the findings to the physician 134 (e.g., via a high-resolution screen and corresponding driver capable of displaying healthcare quality digital images) (block 608).

As described above in connection with FIG. 3, the example physician interactive media device 132 includes a plurality of tools and/or components to enable the physician 134 to generate a report regarding the findings to be conveyed to the patient 138. For example, the physician 134 in the illustrated example uses the speech command interpreter 312 in conjunction with the reference material retriever 314, the annotation unit 316, and/or the findings integrator 318 to generate a report readable and understandable by a typical patient (e.g., without the use of the hands of the physician 134 via voice commands) (block 610). When the physician 134 approves of the report, the physician 134 authorizes the report for release (e.g., signs the report and/or electronically certifies the report) and the report is conveyed to the master record repository 204 at the example IDMS 130 (block 612).

Similar to the notification process described above in connection with block 604, the notification module 206 of the example IDMS 130 facilitates a notification to be conveyed to the patient 138 regarding the newly available physician report (block 614). As described above, the notification module 206 of the example IDMS 130 cooperates with the notifier 400 of the example patient interactive media device 136 and/or the patient workstation 146 to create and present a notification to the patient 138 regarding the availability of the physician report.

In the illustrated example, the patient 138 instructs the synchronization module 402 of the patient interactive media device 136 to synchronize the record library 404 thereof with the master record repository 204 of the example IDMS 130. The synchronization module 402 exchanges information with the master record repository 204 such that the record(s) available in the master record repository 204 associated with the patient 138 (e.g., including the newly generated physician report described above in connection with block 610) are available (e.g., stored on) in the record library 404 (block 616). The records associated with the patient 138 can be determined by referencing the subscriptions stored in the example directory 202 of the example IDMS 130.

When the physician report is available in the record library 404, the patient 138 is able to select the same for presentation. As described above, if possible given the format of the physician report, the report and/or portion(s) thereof are converted to an audio file capable of being presented in conjunction with the visual information associated with the report and/or the healthcare information on which the report and/or the corresponding findings are based. Therefore, in the illustrated example, when the patient 138 selects the findings for presentation, the media player 408 of the example patient interactive media device 136 presents a multimedia (e.g., a visual and/or audio presentation) presentation of the physician report to the patient 138 (e.g., via a high-resolution screen and corresponding driver capable of displaying healthcare quality digital images) (block 618).

As described above in connection with FIG. 4, the example patient interactive media device 136 includes a plurality of tools and/or components to enable the patient 138 to generate a response to the report (e.g., an inquiry) to be conveyed to the physician 134. For example, the patient 138 in the illustrated example uses the speech command interpreter 412 in conjunction with the annotation unit 414 and/or the report integrator 416 to generate a response to the report including questions and/or concerns to be addressed by the physician 134 (e.g., without the use of the hands of the physician 134 via voice commands). If such a response is generated (block 620), the response is conveyed to the master record repository 204 at the example IDMS 130 (block 622). Further, when the patient desires to communicate with the physician (e.g., regarding the newly received and reviewed report) (block 624), the physician communication unit 418 of the example patient interactive media device 136 opens a communication between the patient 138 and the physician 134 as described above in connection with FIG. 3.

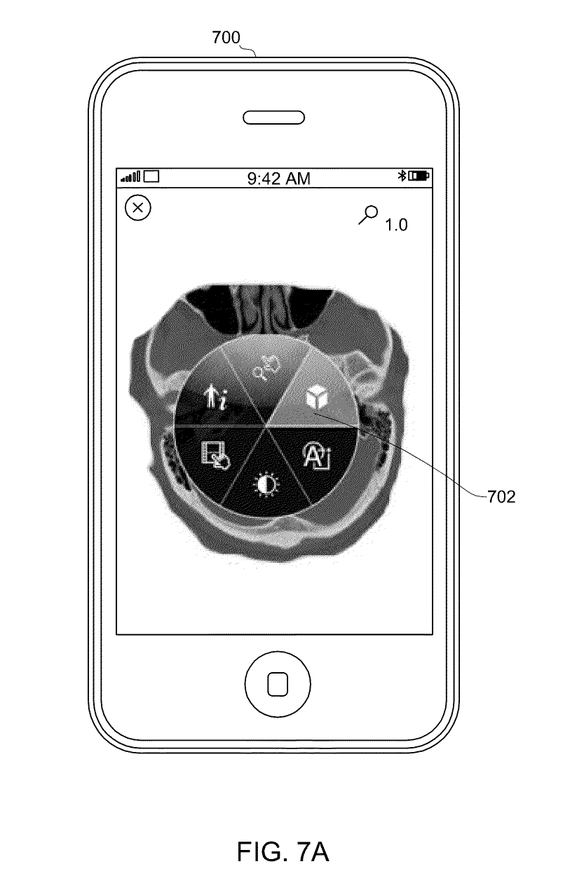

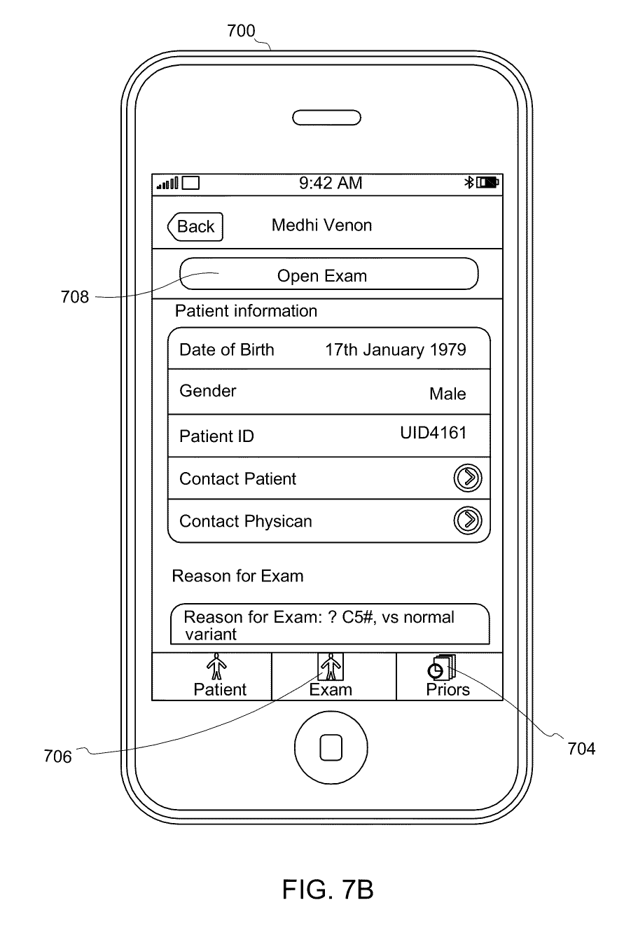

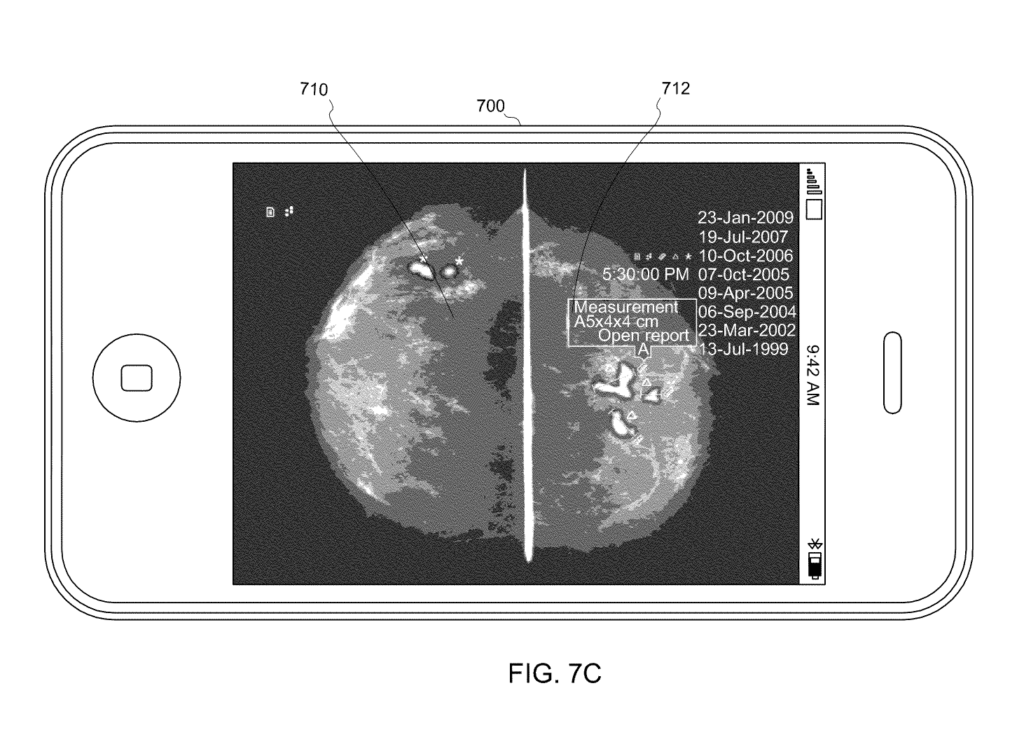

FIGS. 7A-7C illustrate an example device 700 capable of implementing the example physician interactive media device 132 of FIGS. 1 and/or 3 and/or the example patient interactive media device 136 of FIGS. 1 and/or 4. The example 700 of FIGS. 7A-7C is shown for purposes of illustration and not limitation as the example methods, apparatus, systems, and/or articles of manufacture described herein can be implemented by and/or on any suitable device. Generally, the example device of FIGS. 7A-7C is capable of receiving (e.g., using streamlining technology to receive healthcare data), storing, and presenting the information described herein and to receive and implement the instructions described herein (e.g., voice commands and/or tactile user inputs). Further, the example device 700 is capable of communicating wirelessly (e.g., using the 3G protocol, WiFi connectivity, etc.) with, for example, the example network 122 of FIG. 1 and/or other similar devices.

In the illustrated example, the device 700 employs a user interface to enable the physician 134, the patients 138 and 142, and/or any other user to interact with the contents and/or tools of the device 700. The user interface of the example device 700 illustrated in FIG. 7A includes a main menu 702 having a plurality of options that may be selected to perform a plurality of tasks. For example, a settings options enables the user to customize different settings of the device; a worklist option enables the user to retrieve and/or review a list of tasks stored in, for example, a searchable electronic calendar; a media player option associated with the example media players 308 and 408 described above enables the user to engage a multimedia presentation of one or more healthcare documents; an annotation option associated with the annotation units 316 and 414 described above enables the user review a healthcare record (e.g., an image and/or a textual report) and to insert annotations or other related comments; and a patient option enables the user to open one or more files associated with one or more patients.

Regarding the patient option, patient information may be stored in electronic files on the device 700 (e.g., the example record libraries 304 and 404 described above), which may be referred to as patient jackets in the context of the user interface of the device 700. FIG. 7B illustrates a representation of an example patient jacket. The example patient jacket includes general information associated with the corresponding patient such as, for example, bibliographic information, an assigned identifier, a docket identifier, contact information, etc. Further, an example patient jacket includes and/or links to healthcare information associated with the patient such as, for example, the example findings, the example information on which the findings are based, one or more reasons for ordering the analysis corresponding to the findings, and/or the example physician reports based on the findings described above.

The example patient jacket of FIG. 7B includes a first button 704, the engagement of which causes a presentation of one or more links to a medical history (e.g., archived contents of the example record libraries 304 and 404 described above) associated with the identified patient. Further, The example patient jacket of FIG. 7B includes second and third buttons 706 and 708, the engagement of which causes a multimedia (e.g., visual and/or audio information being presented at a substantially similar time) presentation of an available healthcare record (e.g., via the example media players 308 and 408 described above).

FIG. 7C illustrates an example multimedia presentation of an example healthcare record on the example device 700. The example multimedia presentation includes a digital display of an image 710 and a playing of an audio file (e.g., an audio version of textual information associated with the image 710 which has been converted using the text-to-audio converters 306 and 406 described above). The physician 134 and/or the patient 138 may review the healthcare information via the multimedia presentation. Further, as described above, the image 710 and/or any other portion of the healthcare record can be annotated by the physician 134, the patient 138, and/or any other user. In the illustrated example, a key image note (KIN) 712 can be used to annotate the image 710 (e.g., using the annotation units 316 and 414 described above and/or the speech command interpreters 312 and 412 to utilize voice commands). The example KIN 712 of the illustrated example can label an area of interest in the image 710 with textual information. As described above, the textual information can be converted into audio data for an audible presentation to the user.

FIG. 8 is a block diagram of an example processor system 810 that may be used to implement the apparatus and methods described herein. As shown in FIG. 8, the processor system 810 includes a processor 812 that is coupled to an interconnection bus 814. The processor 812 may be any suitable processor, processing unit or microprocessor. Although not shown in FIG. 8, the system 810 may be a multi-processor system and, thus, may include one or more additional processors that are identical or similar to the processor 812 and that are communicatively coupled to the interconnection bus 814.

The processor 812 of FIG. 8 is coupled to a chipset 818, which includes a memory controller 820 and an input/output (I/O) controller 822. As is well known, a chipset typically provides I/O and memory management functions as well as a plurality of general purpose and/or special purpose registers, timers, etc. that are accessible or used by one or more processors coupled to the chipset 818. The memory controller 820 performs functions that enable the processor 812 (or processors if there are multiple processors) to access a system memory 824 and a mass storage memory 825.

The system memory 824 may include any desired type of volatile and/or non-volatile memory such as, for example, static random access memory (SRAM), dynamic random access memory (DRAM), flash memory, read-only memory (ROM), etc. The mass storage memory 825 may include any desired type of mass storage device including hard disk drives, optical drives, tape storage devices, etc.

The I/O controller 822 performs functions that enable the processor 812 to communicate with peripheral input/output (I/O) devices 826 and 828 and a network interface 830 via an I/O bus 832. The I/O devices 826 and 828 may be any desired type of I/O device such as, for example, a keyboard, a video display or monitor, a mouse, etc. The network interface 830 may be, for example, an Ethernet device, an asynchronous transfer mode (ATM) device, an 802.11 device, a DSL modem, a cable modem, a cellular modem, etc. that enables the processor system 810 to communicate with another processor system.

While the memory controller 820 and the I/O controller 822 are depicted in FIG. 8 as separate blocks within the chipset 818, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method for use in a healthcare information system, comprising:
synchronizing a physician record library with a repository to include findings of an analysis performed by a reviewing practitioner, wherein the physician has access to the record library via a first portable device capable of outputting a multimedia presentation of the findings, wherein the first portable device is to enable the physician to modify the findings to generate a report;
in response to receiving the report, synchronizing a patient record library with the repository to include the report, wherein the patient has access to the patient record library via a second portable device capable of outputting a multimedia presentation of the report, wherein the second portable device is to enable the patient to generate a response regarding the report; and
in response to receiving the response from the second portable device, conveying the response to the physician record library.

2. A computer implemented method as defined in claim 1, wherein the first portable device is to enable the physician to modify the findings by receiving voice commands to annotate the findings.

3. A computer implemented method as defined in claim 1, wherein the first portable device is to enable the physician to modify the findings by retrieving reference material related to the findings and inserting the retrieved reference material into the findings to generate the report.

4. A computer implemented method as defined in claim 1, wherein the first portable device is to enable the physician to edit the reference material as inserted into the findings.

5. A computer implemented method as defined in claim 1, wherein the second portable device is to enable the patient to generate the response regarding the report by receiving voice commands from the patient to annotate the findings.

6. A computer implemented method as defined in claim 1, wherein the second portable device is to initiate a communication between the patient and the physician in response to receiving the report.

7. A computer implemented method as defined in claim 6, wherein the communication includes one of an electronic mail message, a telephone call, a short message service (SMS) communication, or a multimedia messaging service (MMS) communication.

8. A computer implemented method as defined in claim 1, wherein the presentation includes a visual representation of the findings and an audio representation of the findings.

9. A computer implemented method as defined in claim 8, wherein the audio representation of the findings is to be generated by converting a textual representation of the findings into the audio representation.

10. An article of manufacture having instructions stored thereon that, when executed, cause a machine to:
synchronize a physician record library with a repository to include findings of an analysis performed by a reviewing practitioner, wherein the physician has access to the record library via a first portable device capable of outputting a multimedia presentation of the findings, wherein the first portable device is to enable the physician to modify the findings to generate a report;
in response to receiving the report, synchronize a patient record library with the repository to include the report, wherein the patient has access to the patient record library via a second portable device capable of outputting a multimedia presentation of the report, wherein the second portable device is to enable the patient to generate a response regarding the report; and
in response to receiving the response from the second portable device, convey the response to the physician record library.

11. An article of manufacture as defined in claim 10, wherein the first portable device is to enable the physician to modify the findings by receiving voice commands to annotate the findings.

12. An article of manufacture as defined in claim 10, wherein the first portable device is to enable the physician to modify the findings by retrieving reference material related to the findings and inserting the retrieved reference material into the findings to generate the report.

13. An article of manufacture as defined in claim 10, wherein the second portable device is to enable the patient to generate the response regarding the report by receiving voice commands from the patient to annotate the findings.

14. A computer implemented method as defined in claim 10, further comprising broadcasting the findings to the first portable device and broadcasting the report to the second portable device.

15. A computer implemented method as defined in claim 10, wherein the second portable device is to initiate a communication between the patient and the physician in response to receiving the report.

16. A computer implemented method as defined in claim 10, wherein the presentation includes a visual representation of the findings and an audio representation of the findings.

17. A portable interactive media device, comprising:
a record library to store a plurality of healthcare records;
a synchronization module to synchronize the record library with a repository;
a text-to-audio converter to convert at least a portion of a first healthcare record reflecting findings of an analysis into an audio representation such that a visual representation of the findings and the audio representation are to be presented to a user at a substantially similar time; and
a report generator to enable the user to modify the first healthcare record to generate a report to be conveyed to a corresponding patient, wherein modifying the first healthcare record is to include retrieving external reference material and inserting the reference material into the findings.

18. A portable interactive media device as defined in claim 17, further comprising an annotation unit to enable the user to modify the first healthcare record by dictating into the device one or more messages to be inserted into the findings as annotations.

19. A portable interactive media device as defined in claim 18, wherein the annotation unit records one or more gestures of a reviewing physician in connection with one or more of the annotations inserted into the findings, and wherein the gestures are played back as one aspect of a multimedia presentation of the report.

20. A portable interactive media device, comprising:
a record library to store a plurality of healthcare records;
a synchronization module to synchronize the record library with a repository;
a text-to-audio converter to convert at least a portion of a first healthcare record reflecting a report generated by a practitioner into an audio representation such that a visual representation of the report and the audio representation are to be presented to a user at a substantially similar time; and
a response generator to enable a patient to generate a response to the report generated by the practitioner, wherein the response is to be conveyed to the practitioner via a management system.

21. A portable interactive media device as defined in claim 19, further comprising an annotation unit to enable the user to modify the report by dictating into the device one or more messages to be inserted into the report as annotations.
